(19) United States
(12) Patent Application Publication
(10) Pub. No.: US 2008/0257802 A1
(43) Pub. Date: Oct. 23, 2008

(54) ADVANCED HOUSEHOLD WATER PURIFICATION MEANS

(76) Inventor: DANIEL D. FRIEL,, Greenville, DE (US)

Correspondence Address: CONNOLLY BOVE LODGE & HUTZ, LLP, P O BOX 2207, WILMINGTON, DE, 19899, US

(21) Appl. No.: 12/103,352

(22) Filed: Apr. 15, 2008

Related U.S. Application Data
(60) Provisional application No. 60/912,439, filed on Apr. 18, 2007.

(51) Int. Cl. B01D 24/42; B01D 21/30

(52) U.S. Cl. 210/109; 210/148

(57) ABSTRACT

An apparatus for purifying and dispensing water of a quality suitable for human consumption comprises a first reservoir for holding unfiltered water. The water moves by the force of gravity downward through a water filtering and purifying cartridge into a second lower reservoir. An electrically powered hydraulic pump and associated electrical controls and plumbing enable the pump to periodically lift water from the second reservoir to the first reservoir to permit its return through the filter thereby enhancing the purity of the water before it is dispensed. The apparatus may include first, second and third reservoirs wherein the first reservoir is nominally at the same level as the second reservoir with the unfiltered or filtered water being pumped from the first reservoir and passed through the filter into the second reservoir. The associated electrical controls and plumbing enable the pump to periodically move water from the second reservoir to the third reservoir from which the water drains by gravity through the filter into the second reservoir thereby enhancing the purity of the water before it is dispensed.

### CROSS-REFERENCE TO RELATED APPLICATION

This application is based upon provisional application Ser. No. 60/912,439 filed Apr. 18, 2007, all of the details of which are incorporated herein by reference thereto.

### FIELD OF INVENTION

This invention relates to novel and versatile but inexpensive means for purification of water in the household environment where there is regular demand for water that is known to be safe for drinking and food preparation.

### BACKGROUND OF THE INVENTION

Many homes depend on municipalities or underground wells for their drinking water and for water used in food preparation. Often such water has an unpleasant odor or taste that makes it undesirable for human consumption. However, such water while unsuitable for drinking is usually believed to be satisfactory for the vast majority of household uses such as bathing, laundry, cleaning and watering of the lawn. Homeowners consequently commonly purchase bottled water for human consumption and related purposes. This however is an expensive solution as some bottled water is more expensive than gasoline.

There is a need consequently in many homes for an inexpensive and convenient means to treat that relatively small fraction of the total household water consumption to a quality level deemed suitable for drinking. It is not necessary to treat all of the household water consumed which would entail very expensive and large equipment and require unnecessary personal attention to keep functioning reliably.

Some homeowners install filtering equipment on the kitchen faucet to provide their drinking water, but this proves to be awkward to use, unattractive, and it is a slow process, often taking minutes to filter just one liter of water. Others use a filtering pitcher which is filled with tap water as needed and stored at room temperature or refrigerated for drinking and cooking.

### SUMMARY OF THE INVENTION

The present invention is several appliances that are versatile but inexpensive and attractive water purifying and dispensing apparatus that can be positioned on a counter near or connected to a source of untreated domestic water. Each has a compartment to hold untreated water that can be filled quickly with a pitcher or it can be connected to and filled directly and automatically thru a small tube connected to the homes central water supply system.

### THE DRAWINGS

FIG. 1 schematically illustrates in cross-section an apparatus in accordance with this invention;

FIG. 2 is a perspective view of the apparatus shown in FIG. 1;

FIG. 3 is a front elevational view of the apparatus shown in FIG. 2;

FIG. 4 is a perspective view of a modified apparatus in accordance with this invention;

FIG. 4A is a front elevational view of the apparatus shown in FIG. 4;

FIG. 4B is a front elevational view partly in section of the apparatus shown in FIGS. 4 and 4A; and

FIG. 5 is a schematic view of a further apparatus in accordance with this invention.

### DETAILED DESCRIPTION

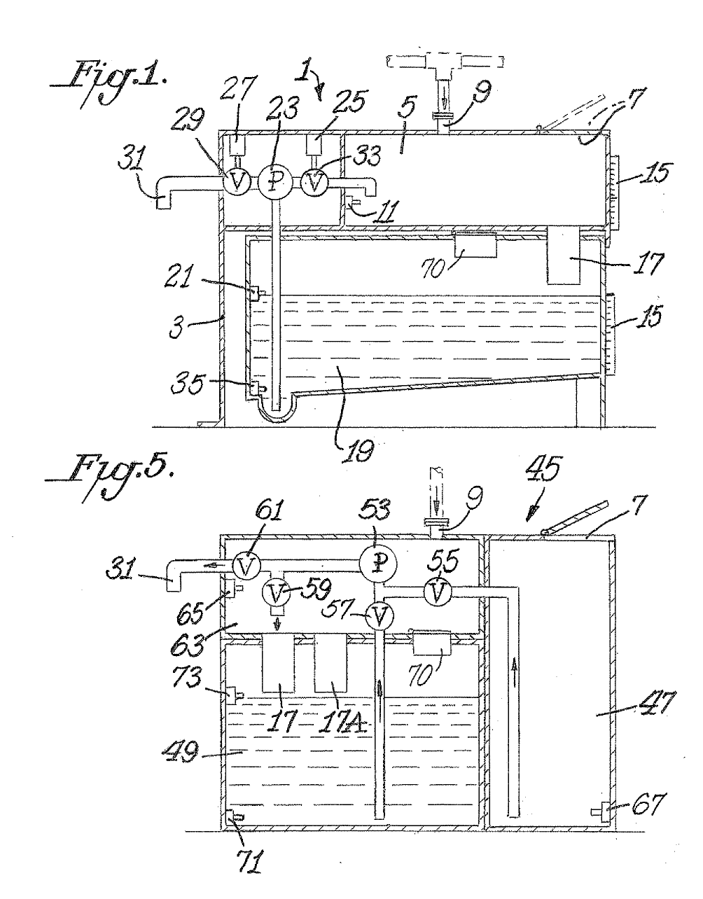

One general concept of this new and novel apparatus is illustrated schematically in FIG. 1 but as described herein this apparatus can take many different forms depending on its degree of automation, the means employed to treat the water, and the extent of personal maintenance required.

The apparatus 1 shown in FIG. 1 comprises of an outer enclosure 3 that houses an upper reservoir 5 used primarily for untreated water. There is a port 7 that can be used to fill manually the reservoir 5 with water or that reservoir can be connected to the household water mains by a small fill pipe 9. A water level switch 1 1 in the upper reservoir can detect the presence of water in that compartment 5. A visual water level gage 15 can be provided to indicate the actual water level in the upper reservoir 5. Indicator lights can be added to advise the user when to add water.

A filter cartridge 17 in this configuration is mounted in the bottom of the upper reservoir 5. Water in the upper reservoir filters thru the cartridge and drains into a lower reservoir 19. A first water level detector 21 is mounted in the lower reservoir to indicate when that reservoir contains a significant amount of filtered water. The lower reservoir can be designed to be removed for cleaning when necessary simply by lifting off the upper portion of the apparatus 1. The water level detector 21 in the lower reservoir 19 can be used to indicate there is sufficient water there for the water pump 23 to re-circulate water from reservoir 19 thru solenoid controlled valve 33 to the upper reservoir 5. If the level in the upper reservoir is at or above the water level detector 11 (in the upper reservoir), the associated circuitry will stop circulation by the water pump until the water level drops below the level of upper detector 11. Further the associated circuitry will not permit the pump to re-circulate the water if the water level in the lower reservoir falls below the level of water level detector 35.

Whenever the water pump 23 is running, either electrical solenoid 25 or solenoid 27 must be actuated to allow water to be re-circulated from the lower reservoir 19 to the upper reservoir 5 or alternatively to be dispensed thru solenoid controlled valve 29 to a faucet 31 and into a vessel, container cup, glass, etc. for its intended use.

This novel arrangement allows the user on command to periodically circulate the water from reservoir 19 to the upper reservoir 5 thereby allowing the water to pass repeatedly thru the water filter 17 which will greatly reduce impurities in the water being held in the reservoir for drinking and food related use. It is possible to program the pump to automatically re-circulate the water any number of times during a selected inactive period such as between midnight and 4:00 am, for example.

This design uniquely permits the storage of a large quantity of water within a relatively small apparatus with a low profile and yet allow filling of tall vessels such as coffee makers, tea makers, kettles and pitchers.

The unique ability of this apparatus to re-circulate the water many times thru the filter can enhance greatly the water purity. It does, however also provide a convenient and unique means to purify the water of bacteria that may not be removed by the filter. The user can simply add a chlorine tablet, such as from dispenser 70, directly into the lower reservoir which will promptly kill any bacteria in that reservoir. Then the chlorine laden water, free of live bacteria, can be transferred to the upper reservoir which will destroy any bacteria that may have accumulated in the plumbing, the pump or the upper reservoir. The chlorine laden water will drain down through the filter which will remove most of the chlorine as the water is returned to the lower chamber nominally free of bacteria and chlorine. More re-circulation will lower the bacteria and chlorine to a lower or negligible level.

This concept can be modified to include multiple filtering elements such as element 17 arranged in parallel to drain and filter the “raw” water as it passes into the lower reservoir 19. This has the advantage that the multiple elements will be sharing the volume of water to be filtered and the multiple filters will reduce the filtering time. Each of the filters will last longer and not have to be replaced as often as a single filter. Flow restricting orifices can, alternatively, be added to multiple filters to slow the flow rate and improve the removal of impurities. FIG. 5 illustrates multiple filters 17, 17A.

Physically this appliance can be designed to fill either short glasses and mugs or to fill higher kettles. Separate filling ports 37 and 39 can be provided as shown in FIG. 2.

Other versions of this concept as described later herein have an electrical docking outlet to mate with cordless electrical kettles while they are being filled by systems as schematically illustrated in FIGS. 1 and 5.

The concept can be further expanded to include heating or cooling structure to dispense hot and cold water after the water is purified as described herein.

An alternative manner of periodically purifying the water and the reservoir is to incorporate a germicidal ultraviolet lamp in each reservoir to shine periodically or for designated periods at consistent times each day or night.

FIG. 3 illustrates a possible design of this type of water purifying apparatus with a kettle 77 positioned below a faucet 37. The kettle can rest on a suitable base 41 which optionally can have a cordless electrical connector built into the base to provide power to the kettle.

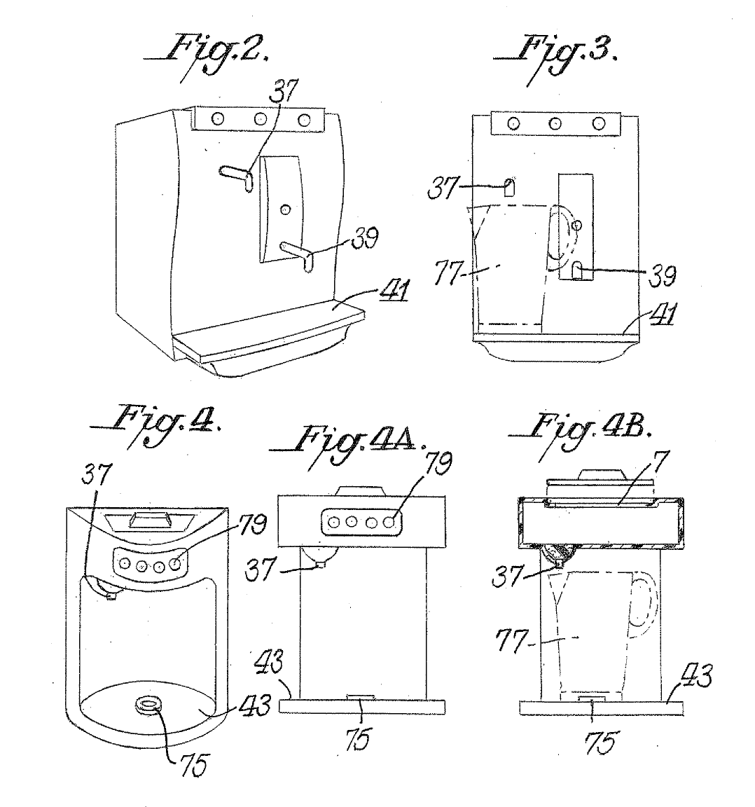

FIGS. 4, 4A and 4B illustrate a simpler system designed to filter, purify and dispense tap water directly into an electric heated kettle that is powered by an electrical connector 75 on the base 43 of this apparatus. The kettle 77 is positioned under the faucet 37, Water placed in the upper reservoir 5 drains thru the filter 17 and faucet 37 and drops into the kettle. A manual or automatic valve, not shown, can be used to initiate the flow of water into the kettle. A power switch on the control panel 79 can actuate the valve to allow water to flow into the kettle and either simultaneously or with a time delay it can turn on the power to the kettle to heat the water therein. Water can be conveniently stored in the reservoir 5 until it is timely to fill the kettle. As illustrated in FIG. 1 a lower water reservoir and pump (not shown in Figures) can be incorporated into this concept to pre-filter and store the purified water in advance of filling the kettle. A pump then could pump the purified water directly into the kettle.

FIG. 5 shows schematically another configuration for a water purifying and dispensing apparatus 45 that can have a lower physical profile than the apparatus of FIG. 1. One major difference is that the reservoir 47 for untreated water can be at about the same elevation as the reservoir 49 for the filtered water. Another difference is the provision of a third and smaller chamber 63 above the filter 17 that can be periodically charged with raw water pumped from reservoir 47. Alternately water can be pumped from reservoir 49 to be filtered and drained back into the treated water reservoir 49. Valves 55 and 57 can be opened or closed appropriately to allow the pump 53 to pump selectively either from reservoir 47 or 49. These valves can be controlled manually or by means of electrically actuated solenoids, for example.

The pump of FIG. 5 can by means of solenoid operated valves 59 and 61 discharge the water into the small reservoir 63 or out of faucet 31, or both.

Level detector 65 in the chamber 63 can alert the electronic control system that the chamber is “filled” and stop the pump. Low level detectors 67 and 71 in reservoirs 47 and 49 can alert the control system and the pump can be stopped to prevent pumping dry those reservoirs. Another level detector 73 in reservoir 49 will alert the control system to the fact that reservoir 49 is “filled” and the pumping of water from reservoir 47 can be stopped until the level recedes.

Visual water gages can be added to the low profile version similar to those shown in FIG. 1. Indicator lights can be provided to advise the user when water can be added.

The advantages of these designs are numerous. The home owner can eliminate the unattractive filtering arrangements sold for attachment to the faucet. These are also slow and difficult for many family members to use. The purifying and dispensing apparatus described here offer the convenience of rapid dispensing because the water can be already fully filtered and ready for use. The amount of offensive impurities can be reduced to far lower levels than with the conventional faucet and pitcher devices that filter the water only once. Multiple filters in parallel can insure faster filtering and lengthen the time before each filter must be changed.

Further the novel apparatus of FIGS. 1 and 5 permits the user to quickly and easily clean the reservoirs and plumbing of all bacteria, that may accumulate over a period of time, simply by adding a chlorine tablet periodically, either manually or by automatic means 70, to the second or both reservoirs and starting an automatic preprogrammed purification program where the pump circulates the chlorine laden water multiple times through the filter or filters simultaneously disinfecting and removing objectionable impurities. Germicidal lamps can be incorporated to further minimize the presence of any bacteria. As necessary the apparatus can be disassembled periodically for visual inspection. Wholly automatic versions that incorporate the features described here can be connected to a pressurized water supply to eliminate the need to manually fill the first reservoir. Anti bacterial agents other than chlorine can be used if appropriate filters are used to remove the alternate agents.

The apparatus can contain user friendly controls that allow the user to select how often he wishes to recirculate the water in order to realize lower impurity levels. He can select the time of day or night to re-circulate and determine when he wishes to run a sanitizing cycle. Detectors can be added to alert the user when the total impurity level is too high or when selected impurities are beyond specified levels.

What is claimed is:

1. An apparatus for purifying and dispensing water of a quality suitable for human consumption comprising a water filtering and purifying cartridge, a first reservoir for holding unfiltered or filtered water mounted at least in part above a second lower reservoir for holding water that has first moved from said first reservoir by force of gravity downward thru said filter into said second reservoir, an electrically powered hydraulic pump and associated electrical controls and plumbing to enable said pump to periodically lift water from said second reservoir to said first reservoir to permit its return thru said filter, thereby enhancing the purity of the water before it is dispensed.

2. An apparatus according to claim 1 where said filter and purifying cartridge removes chlorine from the water, comprising in addition a manual or automatic system to dispense periodically one or more chlorine generating tablets into the water within said second reservoir that will reduce bacterial contamination therein and upon its circulation to said first reservoir by said pump the chlorine containing water will decontaminate the pump and associated plumbing and said first reservoir, the added chlorine being removed by said filter as the water returns to said second reservoir.

3. An apparatus according to claim 1 that comprises an extended base structure to support an electric water kettle, beverage making container or food preparation vessel as it is being filled and to provide a corded or cordless electrical power socket that provides power to the kettle or container.

4. An apparatus according to claim 1 including a dispensing spout communicating with said second reservoir for dispensing filtered water from said second reservoir.

5. An apparatus for purifying and dispensing water of a quality suitable for human consumption comprising a water filtering and purifying cartridge, an electrically powered hydraulic pump with associated electrical controls and plumbing, a first, second and third reservoirs, said first reservoir for holding unfiltered or filtered water mounted at nominally the same level as said second reservoir for holding water that has been pumped from said first reservoir and passed thru said filter into the second reservoir, said associated electrical controls and plumbing enabling said pump to periodically move water from said second reservoir to said third reservoir from which the water drains by gravity through said filter into said second reservoir, thereby enhancing the purity of the water before it is dispensed.

6. An apparatus according to claim 5 where said filter and purifying cartridge removes chlorine from the water, comprising in addition a manual or automatic system to dispense one or more chlorine generating tablets into the water within said first and second reservoirs thereby reducing bacterial contamination therein and to direct the recirculation of the chlorine laden water by said pump through said third chamber and said filter to decontaminate said pump, and said associated plumbing and said third chamber and to remove the added chlorine from the water before it is dispensed.

7. An apparatus according to claim 5 that comprises an extended base structure to support an electric water kettle, beverage making container or food preparation vessel as it is being filled and to provide a corded or cordless electrical power socket that provides power to the kettle or container.

8. An apparatus according to claim 5 including a dispensing spout communicating with said second reservoir for dispensing filtered water from said second reservoir.
